(19) United States
(12) Patent Application Publication
(10) Pub. No.: US 2014/0020289 A1
(43) Pub. Date: Jan. 23, 2014

(54) DEVICE FOR DISPLAYING FLOWER BOUQUETS OR POTTED PLANTS

(71) Applicant: Philippe Charrin, Beaumont-Monteux (FR)

(72) Inventor: Philippe Charrin, Beaumont-Monteux (FR)

(21) Appl. No.: 14/003,088

(22) PCT Filed: Mar. 9, 2012
(86) PCT No.: PCT/EP2012/054130

§ 371 Date: Oct. 3, 2013

(30) Foreign Application Priority Data
Mar. 9, 2011 (LU) 91796

(51) Int. Cl. A01G 5/02

(52) U.S. Cl. CPC A01G 5/02
USPC 47/41.01

(57) ABSTRACT

The present invention relates to a device for displaying flower bouquets or potted plants, including a first sheet (1), a central part (2), and a second sheet (4), said central part (2) being inserted between the first sheet (1) and the second sheet (4). Said first sheet (1) is stacked on top of said second sheet (4). Said device is characterized in that the central part includes a central body (2A) and at least two foldaway arms (3) rigidly connected to the central body (2A), and in that, when erecting the device, the angle formed between the central body (2A) and the at least two foldaway branches (3) is either less than 90° in the case of a device for displaying flower bouquets, or no less than 90° in the case of a device for displaying potted plants.

### FIELD OF THE INVENTION

The present invention relates to a device for displaying flower bouquets and potted plants according to claim 1.

### BACKGROUND OF THE INVENTION

EP 0828446 (Charrin) illustrates a device for displaying flower bouquets comprising a stiff conical support and a single sealed (water-resistant) sheet.

FR 28970832 (Ricci) illustrates a flower vase comprising a polygonal central part and at least one stiff jointed branch which may be detached from this central part.

DE 10303192 illustrates a flower vase comprising a first sheet, a central part and a second sheet, the central part does not comprise any branches and is comprised between the sheets but the two sheets are not superposed.

U.S. Pat. No. 5,781,981 discloses in FIGS. 2A, 2B, 2C and 3B, a device for displaying flower pots comprising a first sheet, a string and a second sheet, the string does not comprise any branches.

GB 2,378,127 discloses a device for displaying flower bouquets comprising a first sheet, a string and a second sheet, the string does not comprise any branches.

FR 8516448 discloses a container formed by a cardboard blank and by a single flexible and sealed sheet, the blank has a round central portion and flaps radiating as a 6-pointed star, the ends of the points of which each have the same width. The present invention differs from FR 8516448 from the fact that a central star-shaped part is inserted between two superposed sheets.

WO 02/20372 discloses a portable packaging device for a flower bouquet.

### SUMMARY OF THE INVENTION

The present invention is intended for florists capable of stabilizing flower bouquets without any assistance other than the simple fact of crossing the stems of the bouquet and of packaging the whole in one or two sealed (water-resistant) sheets and/or of using a commercial flower bouquet support and/or packaging a pot.

The present invention allows customization of the flower bouquet and of pots. The present invention uses a fine cardboard insert (2) of low basis weight (preferably not water-resistant) and forms the solution of a package ready for use:
for florists crossing the stems in order to stabilize a flower bouquet and not using any support and wishing to produce stable bouquets without considerably changing their approach to the assembling of a flower bouquet.
and/or for florists using a flower bouquet support
and/or for potted plants

### BRIEF DESCRIPTION OF THE DRAWINGS

FIG. 1 illustrates the first sheet (1) laid flat.

FIG. 2 illustrates the central polygonal part (2) laid flat comprising a central body (2A), at least two branches (3) (8 branches in this figure) secured to this polygonal central part and said branches (3) have a lower end (3A) and an upper end (3B), the lower end (3A) being secured to the central body (2A) and the upper end (3B) being defined as being the portion of the branches (3) furthest away from the central body (2A), and the lower end (3A) is wider than the upper end (3B).

FIG. 3 illustrates the polygonal central part (2) laid on the top of the first sheet (1).

FIG. 4 illustrates the polygonal central part (2) inserted between the first sheet (1) and the second sheet (4). The second sheet (4) laid flat being crossed or shifted relatively to the flat or aligned first sheet (1).

FIG. 5 illustrates the polygonal central part (2) inserted between the first sheet (1) and the second sheet (4) and the second sheet is thermo-welded (5) to the first sheet, the thermo-weld (5) surrounding the polygonal central part (2).

FIG. 6 illustrates the second sheet (4) which is crossed or shifted relatively to the first sheet (1) (when laid flat, a star-shape is obtained) or aligned.

FIG. 7 illustrates the partly thermo-welded (5) device of FIG. 6 and forming a housing (6) for receiving the polygonal central part (2).

FIG. 8 shows how the polygonal central part (2) is inserted between the first sheet (1) and the second sheet (4) inside the partly thermo-welded (5) housing (6).

FIG. 9 illustrates the polygonal central part (2) inserted inside the partly thermo-welded (5) housing (6).

FIG. 10 illustrates a flower bouquet (7) laid on the second sheet (4) and in the center of the polygonal central part (2).

FIG. 11 illustrates the providing of volume to the device of the present invention which packages the bouquet of flowers (7), i.e. the device of FIG. 10 which is raised in order to wrap the stems of the bouquet of flowers (7) or of the potted plant.

FIG. 12 illustrates the final device, to which volume was provided, and attached by a tie (8) at the upper portion of the device.

FIG. 13 illustrates the device of the present invention showing two carrying handles (9) attached to two sheets (1 and 4) and a wire clamp (10) passing between both carrying handles (9) and being held in place by a thermo-weld (5) between the first (1) and the second sheet (4) and surrounding the polygonal central part (2).

FIG. 14 illustrates the device of FIG. 13 as seen from above showing the wire clamp (10) held by thermo welding (5) between both sheets (1 and 4) and surrounding the polygonal central part (2).

FIG. 15 illustrates the device of FIG. 13 without any wire clamp.

FIG. 16 illustrates the providing of volume to the device of FIGS. 14 and 15 with carrying handles and with a bouquet of flowers and the wire clamp (10) or carrying handles (9) holding the device in place around the stems of the bouquet of flowers.

FIG. 17 illustrates the central part (2) exclusively adhesively bonded or welded to its periphery under the sheet (1), i.e. outside this sheet (1).

FIG. 18 resumes application around a potted plant.

FIG. 19 resumes attachment by tying by means of a tie (8) around the potted plant.

FIG. 20 illustrates the device of FIG. 19 further including two carrying handles and a wire clamp.

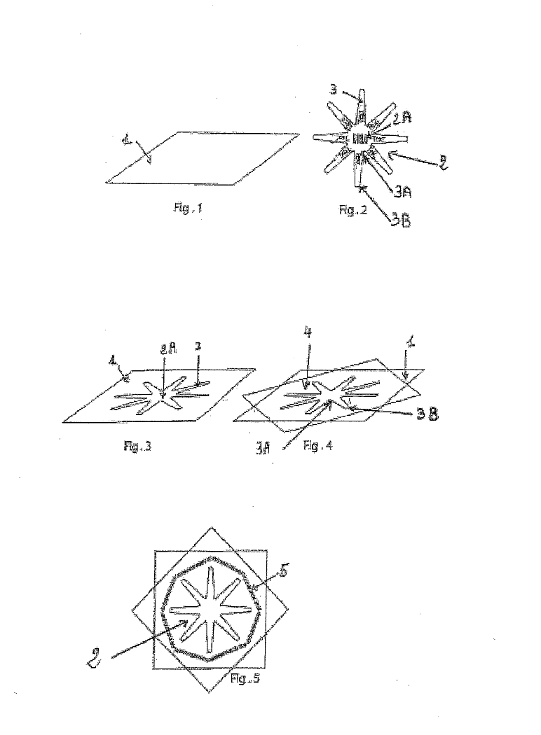

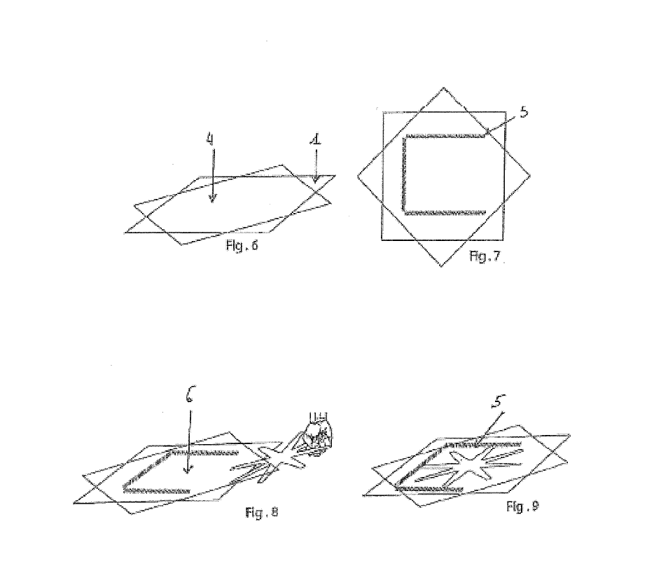

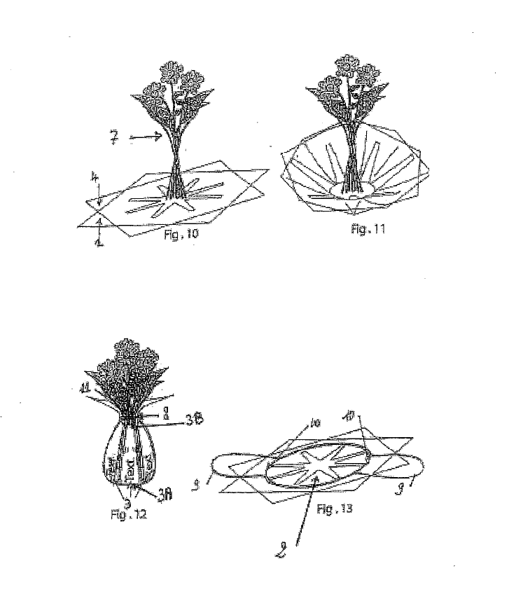

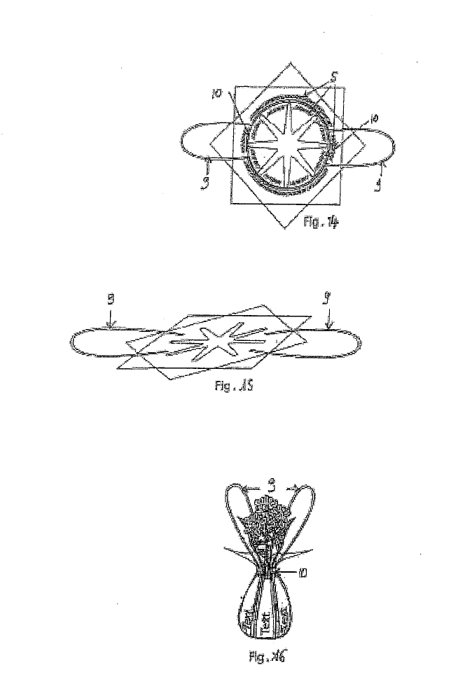

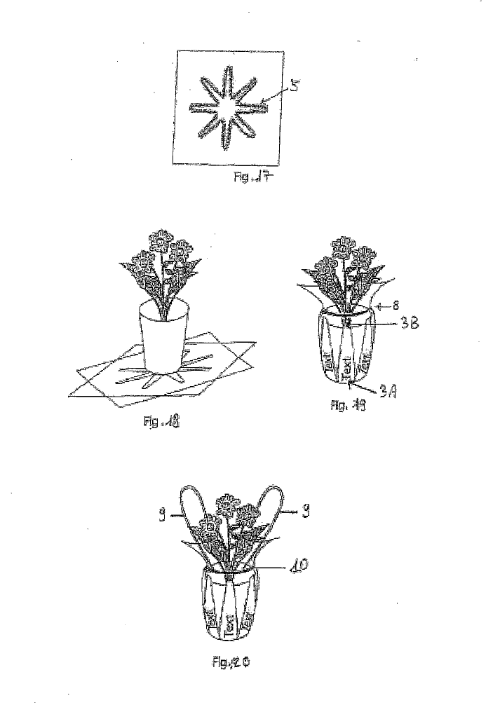

### DETAILED DESCRIPTION OF THE ILLUSTRATIVE EMBODIMENT

The present invention facilitates the specific labeling by a graphic illustration of the polygonal central part (2), either directly on the central part or on at least one branch (3) of the polygonal central part (2). This device has the advantage of providing (digital or offset) quality communication to the customers of florists for example by means of readable printed bar codes at the cash register by centered horizontal read-out. The graphic illustration gives the possibility of printing texts or a logo on the polygonal central part and of multiplying the color combinations ad infinitum which is impossible by direct printing on a sealed (water-resistant) sheet.

An embodiment of the present invention consists of one or two sealed (water-resistant) sheets (1 and 4), of a polygonal or circular central part (2) (cross) in fine cardboard printed on the visible face of the latter so as to be seen from the outside by a human being. The polygonal or circular central part (2) (cross) is laid with the printed side on the top of the first transparent (3) sheet (1). A second transparent sheet (4) is laid in an aligned or crossed way relatively to the first transparent (or colored) sheet. The whole of the two sheets is welded by thermo-welding (5) at the periphery of the polygonal (cross) central portion. The welding technique may comprise the thermal, high frequency, pulsed and ultrasonic technique. The cross may also be adhesively bonded or welded (D) to the sealed (water-resistant) sheet and used outside the thereby produced water reserve or the pot (FIG. 20). Preferably the cross is found on the outside of the package, i.e. on the face of the sheet which is not in direct contact with water or with a flower pot. The technical effect related to the fact of welding together both sheets (between which the cross is slipped on) gives the possibility of providing high stability to the bouquet in spite of the small thickness of the sheets.

A thickness range of the sheets is comprised between 0.1 mm and 1 mm and the type of material used is a plastic sheet. A cross welded to one or two sheets provides better stabilization and stiffening of the central part.

Both sheets may either be transparent or tinted, or one being transparent and the other one tinted.

Both sheets may be welded on three sides (FIG. 7) so as to generate a housing (6) for inserting the polygonal central part. The florist may thus house the polygonal central part in this housing. It should be noted that the innovative aspect of these welds is that they are always placed above the water level, at the tie level, thereby providing increased reliability of the welds, and guaranteeing a perfect seal.

The simple fact of entirely welding at the periphery of the cross gives the possibility by simple tearing, of separating the printed sheet from the polypropylene sheet and thus provides an environmental advantage. The fact of being able to house the polygonal central part (cross) in a housing (6) also gives the possibility of being able to remove this polygonal central part (cross) upon controlled selected sorting (recycling).

The devices of the prior art did not allow or only with difficulty, separation of the various components, these devices are often unsuitable for recycling but never with the purpose of communication.

The assembling of this novel device for displaying a flower bouquet is accomplished by placing in its center the bouquet of flowers and having the sheets move along the stems of the bouquet and/or of the potted plant, for example by pushing the whole of the device into a hole made in a table in order to provide volume to the device. Thus, a novel device for displaying a flower bouquet (package) is obtained by attaching a tie (8) (for example a ribbon) to the top of this device (this tie retaining both sheets and the stems of the flowers). The branches of the polygonal central part show a graphic illustration (FIG. 16) which may be seen by the potential users since it is perfectly centered, visible and readable over 360°, which is not provided by any direct print on a sheet commonly used with or without an internal support which creases and is folded haphazardly making its reading very difficult and uncertain in this location.

The assembling of this novel device for displaying a potted plant is accomplished by placing in its center the pot and having the sheets move up along the wall of the pot, for example by pushing the whole of the device into a hole made in a table in order to provide volume to the device. Thus, a novel device for displaying a potted plant (package) is obtained by attaching a tie (8) to the top of this device (this tie retaining both sheets and the potted plant). The branches of the polygonal central part show a graphic illustration (FIG. 12 and FIG. 16) which may be seen by potential users since it is perfectly centered, visible and readable over 360°, which is not provided by any direct print on a sheet commonly used with or without an internal support which creases and is folded haphazardly making its reading very difficult and uncertain in this location.

In another embodiment, a wire clamp (10) may also be incorporated between both welded sheets (FIG. 14), which through its passing between the weld beads (5) allows the bag to be closed by traction. This gives the possibility of not having to pierce the sealed (water-resistant) sheets at the level of the tie (or constriction) and therefore avoids possible water leaks. The carrying handles (9) greatly jut out from the top portion of the device and thus do not allow any leak in the low portion of the device. The carrying handles are attached in the upper portion of the device.

The device for displaying flower bouquets or potted plants comprising a first sheet, a polygon-shaped central part and a second sheet characterized in that this central part is inserted between this first sheet and the second sheet, is defined in claim 1.

The device for displaying the flower bouquets and/or potted plants may also comprise a single sheet, a polygon-shaped central part characterized in that this central part is welded or adhesively bonded on one face and on its outer portion.

In a first embodiment, the central part may be made in a stiff or non-stiff material. The first sheet and/or the single sheet, the central part of the second sheet are flat before providing any volume. The single sheet and/or the first sheet and the second sheet may be translucent and waterproof. The single sheet and/or the first sheet and the second sheet may be translucent or not and not waterproof. The central part may either be waterproof or not and water-resistant or not. The central part may be covered with graphic illustration(s). The central part comprises at least one branch secured to this central part. At least one branch may be covered with a graphic illustration. All the branches are secured to this central part. All the branches may be covered with a graphic illustration. The second sheet may be partly thermo-welded to the first sheet so as to provide a housing for the stiff or non-stiff polygon-shaped central part. The central part may also be welded or adhesively bonded to a single sheet and placed outside the reserve of water. Upon providing volume to the device, the first sheet and the second sheet are raised along at least one branch of the polygonal central part and surround the stems of flowers and/or the potted plant, the whole being held in place with a tie. The whole is laid out so as to allow air and/or water to pass through an orifice located at the upper portion of the device. At least one carrying handle may be held in place between the first and second sheet by a thermo-weld between this first and this second sheet. The thermo-weld holds in place the carrying handle and the polygonal central part. A wire clamp (10) may be attached to at least one carrying handle (9) and is held in place with the polygonal or circular central part (2) by thermo-welding (5) between both sheets.

The present invention may relate to a device for displaying flower bouquets or potted plants comprising a first sheet (1), a central part (2) and a second sheet (4), said central part (2) being inserted between the first sheet (1) and the second sheet (4), said first sheet (1) being superposed to said second sheet (4), said device being characterized in that the central part comprises a central body (2A) and at least two foldaway branches (3) secured to the central body (2A), and in that said at least two foldaway branches (3) of said device may either adopt a conical shape if upon shaping, the device is intended to display a bouquet of flowers, or said at least two branches (3) of said device may adopt a V shape if upon shaping, the device is intended to display potted plants.

The present invention relates to a device for displaying flower bouquets or potted plants comprising a first sheet (1), a central part (2) and a second sheet (4), said central part (2) being inserted between the first sheet (1) and the second sheet (4), said first sheet (1) being superposed to said second sheet (4), said device being characterized in that the central part comprises a central body (2A) and at least two foldaway branches (3) secured to the central body (2A), and in that upon providing volume to the device, the angle formed between the central body (2A) and said at least two foldaway branches (3) is either less than 90° in the case of a device for displaying flower bouquets, or equal to 90° or more than 90° in the case of a device for displaying potted plants.

The device of the present invention may also be characterized in that said at least two foldaway branches (3) are of trapezoidal shape and have a lower end (3A) and an upper end (3B), the lower end (3A) being secured to the central body (2A) and the upper end (3B) being defined as being the portion of said at least two foldaway branches (3), the furthest away from the central body (2A), and in that the lower end (3A) is wider than the upper end (3B). The device of the present invention may also be characterized in that the central part (2) comprises at least 2, 3, 4, 5, 6, 7, 8, 9, 10, 11, 12, 13, 14, 15, 20, 25, 30, 40, 50 or still more foldaway branches (3).

In a second embodiment, the device for displaying flower bouquets and potted plants of the present invention may comprise a single sheet (1) and a central part (2), said central part (2) is welded to the outer face of the sheet (1), i.e. the face of the sheet (1) not being in contact with water or with a flower pot. The advantage of the solution as compared with the prior art is notably the possibility of using a non-water-resistant cardboard cross which is less expensive than a plastic part. A cross welded to a sheet allows better stabilization and stiffening of the central part. The characteristics of the first embodiment also apply to the second embodiment.

What is claimed:

1. A device for displaying bouquets of flowers or potted plants comprising a first sheet (1), a central part (2) and a second sheet (4), said central part (2) being inserted between the first sheet (1) and the second sheet (4), said first sheet (1) being superposed to said second sheet (4),
said device being characterized in that
the central portion comprises a central body (2A) and at least two foldaway branches (3) secured to the central body (2A), and
in that upon providing volume to said device, the angle formed between the central body (2A) and said at least two foldaway branches (3) is either less than 90° in the case of a device for displaying flower bouquets, or equal to 90° or greater than 90° in the case of a device for displaying potted plants.

2. The device according to claim 1, characterized in that said at least two foldaway branches (3) have a lower end (3A) and an upper end (3B), the lower end (3A) being secured to the central body (2A) and the upper end (3B) being defined as being the portion of said at least two foldaway branches (3), the furthest away from the central body (2A) and in that the lower end (3A) is wider than the upper end (3B).

3. The device according to claim 1, characterized in that said at least two branches (3) are of trapezoidal shape.

4. The device according to claim 1, characterized in that the central part comprises at least 8 foldaway branches (3).

5. The device according to claim 1, characterized in that the central body (2A) is of a polygonal or circular shape.

6. The device according to claim 1, characterized in that the central part is made in a non-stiff and non-water-resistant material.

7. The device according to claim 1, characterized in that the first sheet (1) and the second sheet (4) are translucent or non-translucent and water-resistant sheets.

8. The device according to claim 1, characterized in that the first sheet (1) and the second sheet (4) are translucent or non-translucent and non-water-resistant sheets.

9. The device according to claim 1, characterized in that the branches (3) may be covered with a graphic illustration.

10. The device according to claim 1, characterized in that the second sheet (4) is partly welded (5) to the first sheet (1) so as to provide a housing (6) for the central part (2).

11. The device according to claim 1, characterized in that the second sheet (4) is entirely welded (5) to the first sheet (1) all along the periphery of the central part (2).

12. The device according to claim 1, characterized in that upon providing volume to the device, the first sheet (1) and the second sheet (4) are raised along said at least two branches (3) of the central part (2) and surround the stems of flowers, the whole being held in place with a tie (8).

13. The device according to claim 1, characterized in that at least one carrying handle (9) is held in place by attachment to the first sheet (1) and to the second sheet (4).

14. The device according to claim 13, characterized in that a wire clamp (10) is attached to at least one carrying handle (9) and is held in place with the polygonal central part (2) by thermo-welding (5).
